(19) United States
(12) Patent Application Publication
(10) Pub. No.: US 2003/0185597 A1
(43) Pub. Date: Oct. 2, 2003

(54) PROCESS CARTRIDGE TONER SUPPLY ARRANGEMENT FOR IMAGE FORMING APPARATUS

(76) Inventors: Jui-Chi Wang, Taichung (TW); Robin Hsu, Taichung City (TW); Ya Li Huang, Taichung (TW); Kuan Tung Li, Yunlin (TW); Shu Hui Wang, Taichung (TW); Smarla Hui Wang, Taichung (TW); Ting-Hsuan Ko, Taichung (TW); Renhao Liu, Taichung (TW); Hui-Wen Hsieh, Feng-Yuan City (TW)

Correspondence Address: MERCHANT & GOULD PC, P.O. BOX 2903, MINNEAPOLIS, MN, 55402-0903, US

(21) Appl. No.: 10/171,039

(22) Filed: Jun. 11, 2002

(30) Foreign Application Priority Data
Feb. 8, 2002 (TW) 091201947

(51) Int. Cl. G03G 15/08

(52) U.S. Cl. 399/258; 399/260

(57) ABSTRACT

A process cartridge toner supply arrangement used in a laser printer for controlling supply of toner is constructed to include a receiving member, the receiving member having toner receiving openings and a toner accommodating portion, a replaceable supplying member, the supplying member having a toner accommodating portion and toner supplying openings, and a blocking member provided between the receiving member and the supplying member and moved to close/open the toner passage between the toner receiving openings and the toner supplying openings.

### BACKGROUND OF THE INVENTION

1. Field of the Invention

The present invention relates to a process cartridge and, more particularly, to a process cartridge toner supply arrangement used in a laser printer for controlling the toner passage between the toner container and the developing device.

2. Description of the Related Art

A regular process cartridge for a laser printer is generally comprised of an electrophotographic photosensitive member, developing means, charging means, cleaning means, and a toner container. When the toner of the toner container used up, the whole assembly of the process cartridge becomes useless and must be thrown away. It is not economic to throw the whole assembly of the process cartridge away after empty of the process cartridge. Further, the waste process cartridge may cause pollution to the environment if it is not well disposed of.

### SUMMARY OF THE INVENTION

The present invention has been accomplished to eliminate the aforesaid drawbacks. It is the main object of the present invention to provide a sliding cover device arrangement for controlling toner passage between the toner container and developing device of an image forming apparatus, which enables the user to replace the toner container without throwing the whole assembly of the process cartridge when toner of the toner container used up. To achieve these and other objects of the present invention, the process cartridge toner supply arrangement comprises a receiving member (developing device), the receiving member comprising a plurality of toner receiving openings and a toner accommodating portion adapted for accommodating toner received from the toner receiving openings; a supplying member (toner container), the supplying member comprising a toner accommodating portion adapted for accommodating toner and a plurality of toner supplying openings adapted for supplying toner from the toner accommodating portion of the supplying member to the toner accommodating portion of the receiving member through the toner supplying openings and the toner receiving openings; and a blocking member provided between the receiving member and the supplying member and moved to close/open the toner passage between the toner receiving openings and the toner supplying openings.

### BRIEF DESCRIPTION OF THE DRAWINGS

FIG. 1 is an exploded view of the first embodiment of the present invention.

FIG. 2 is an elevational assembly view of the first embodiment of the present invention.

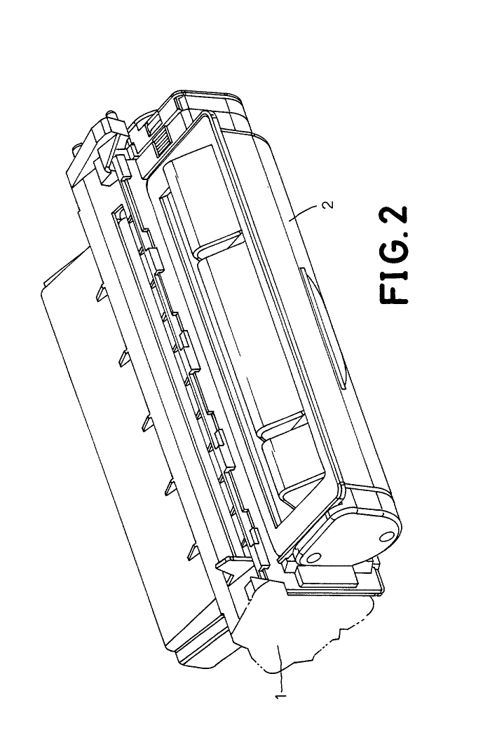

FIG. 3 is a back side view of the developing device, showing the first sliding cover moved to the open position and the toner receiving openings opened according to the first embodiment of the present invention.

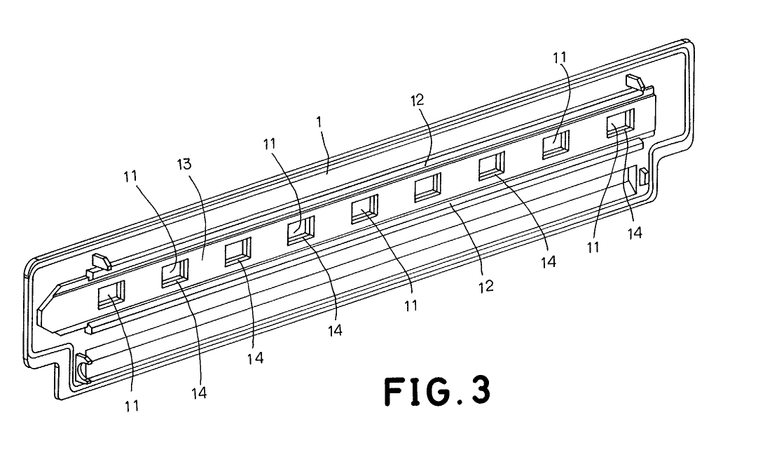

FIG. 4 is similar to FIG. 3 but showing the first sliding cover moved to the close position and the toner receiving openings closed according to the first embodiment of the present invention.

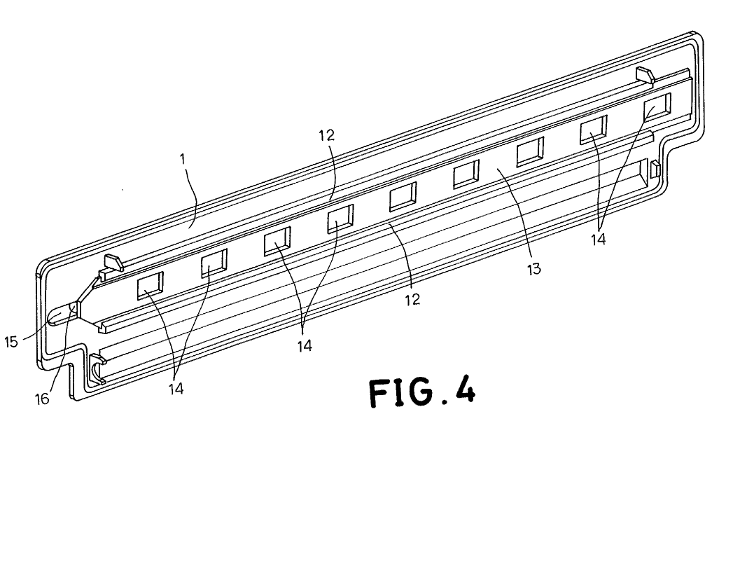

FIG. 5 is a back side view of the toner container, showing the second sliding cover moved to the opening position and the toner supplying openings opened according to the first embodiment of the present invention.

FIG. 6 is similar to FIG. 5 but showing the second sliding cover moved to the close position and the toner supplying openings closed according to the first embodiment of the present invention.

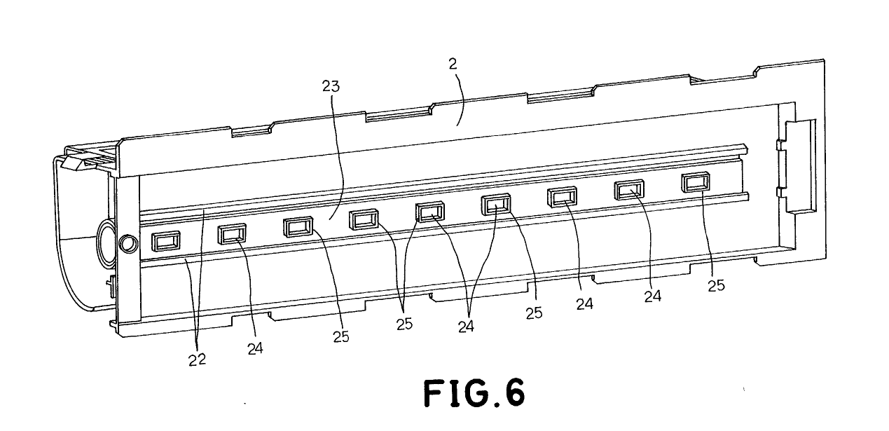

FIG. 7 is a sectional elevation of the first embodiment of the present invention, showing the toner container coupled to the developing device.

FIG. 8 is an exploded view of the second embodiment of the present invention.

FIG. 9 is an elevational assembly view of the first embodiment of the present invention.

### DETAILED DESCRIPTION OF THE PREFERRED EMBODIMENT

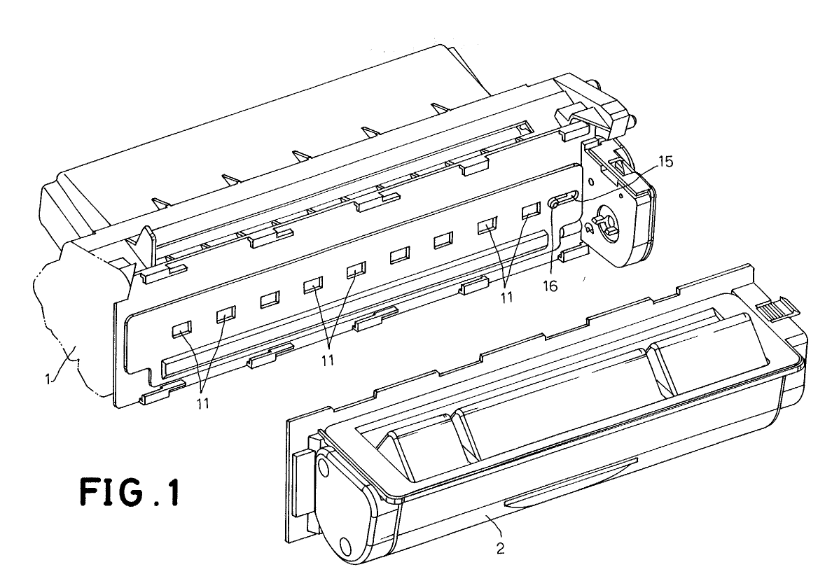

Referring to FIG. 1, a process cartridge toner supply arrangement is shown comprised of a receiving member, a replaceable supplying member, and a blocking member. The receiving member is a developing device 1. The supplying member is a toner container 2. The developing device 1 comprises a plurality of toner receiving openings 11 arranged in a line in one side thereof, and a toner accommodating portion adapted for accommodating toner. There are electrophotographic photosensitive means, developing means, charging means, and cleaning means provided inside the toner accommodating portion of the developing device 1. Because the internal structure of the developing device 1 is of the know art and not within the scope of the claims of the present invention, no further detailed description on this part is necessary.

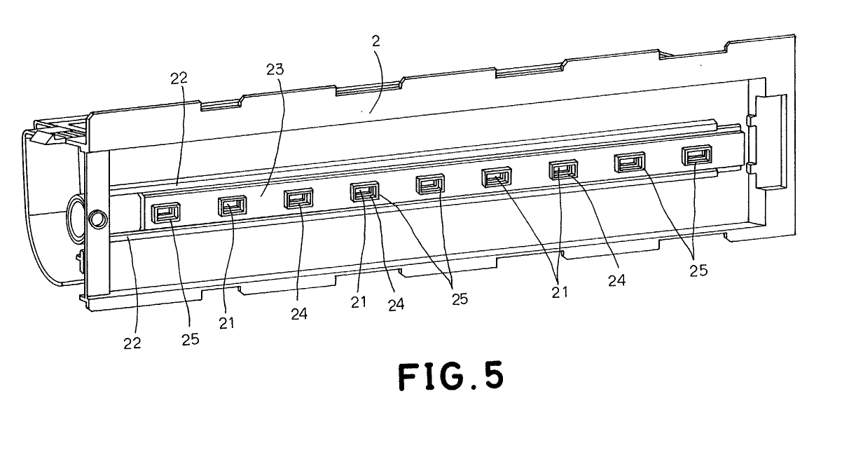

Referring to FIG. 5 and FIG. 1 again, the toner container 2 comprises a plurality of toner supplying openings 21 arranged in a line in one side thereof corresponding to the toner receiving openings 11 of the developing device 1 and adapted for guiding toner from the toner accommodating portion defined inside the toner container 2 to the toner accommodating portion of the developing device 1 through the toner receiving openings 11.

Referring to FIGS. from 3 through 6 and FIG. 1 again, the aforesaid blocking member, according to a first embodiment of the present invention, comprises a first sliding cover 13, a second sliding cover 23, and engagement means. The developing device 1 comprises two elongated guide members 12 arranged in parallel at different elevations above and below the toner receiving openings 11. The first sliding cover 13 is inserted in between the guide members 12 and moved to close/open the toner receiving openings 11. The first sliding cover 13 comprises a plurality of openings 14 corresponding to the toner receiving openings 11. The aforesaid engagement means comprises a sliding slot 15 formed in the developing device 1 in line with the toner receiving openings 11 at one side, a projection rod 16 protruded from one end of the first sliding cover 13 and inserted through the sliding slot 15, and a retaining hole 25 formed in the toner container 2 in line with the toner supplying openings 21 and adapted for receiving the projection rod 16. The toner container 2 further comprises two elongated guide members 22 arranged in parallel at different elevations above and below the toner supplying openings 21. The second sliding cover 23 is inserted in between the guide members 22 and moved to close/open the toner supplying openings 21. The second sliding cover 23 comprises a plurality of openings 24 corresponding to the toner supplying openings 21. The aforesaid engagement means further comprises a plurality of projections 26 respectively protruded from the second sliding cover 23 around each of the openings 24 and adapted for engaging into the toner receiving openings 11 of the developing device 1.

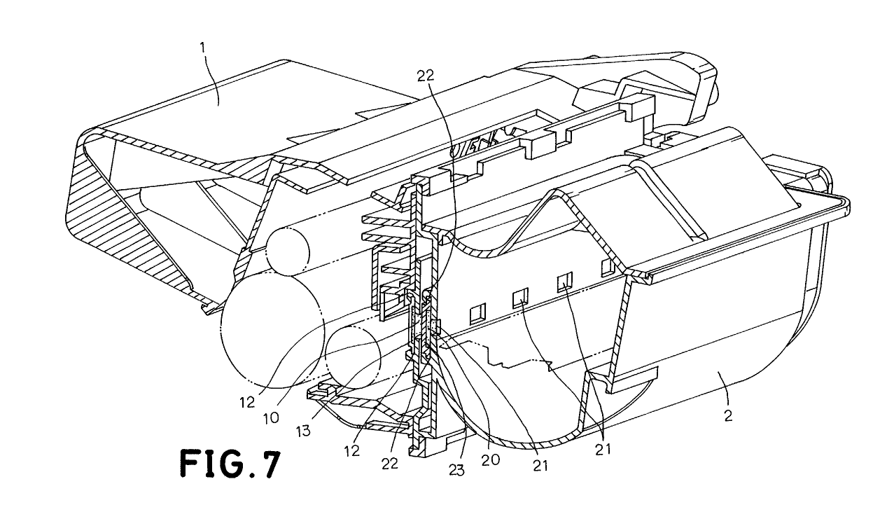

Referring to FIG. 7 and FIG. 1 again, when the toner container 2 and the developing device 1 are coupled together and set in the open position, the toner container 2 and the developing device 1 are maintained closely attached to each other, keeping the projection rod 16 engaged into the retaining hole 25 of the toner container 2 and the projections 26 respectively engaged into the toner receiving openings 11 of the developing device 1. When pushed the toner container 2 sideways after installation in the image forming apparatus (not shown), the first sliding cover 13 and the second sliding cover 23 are moved in between the respective guide members 12;22 in same direction to force the openings 14 into alignment with the toner receiving openings 11 respectively. At this time, the toner supplying openings 21 of the toner container 2 are respectively aimed at the toner receiving openings 11 of the developing device 1 for the passing of toner from the toner container 2 to the developing device 1.

On the contrary, when pushed the toner container 2 sideways in the reversed direction, the first sliding cover 13 and the second sliding cover 23 are moved in the reversed direction, thereby causing the first sliding cover 13 and the second sliding cover 23 to close the toner receiving openings 11 and the toner supplying openings 21, and therefore the toner passage between the toner container 1 and the developing device 2 is shut off.

Referring to FIG. 7 again, sponge linings 10;20 are respectively installed in between the developing device 1 and the first sliding cover 13 around the toner receiving openings 11 and in between the toner container 2 and the second sliding cover 23 around the toner supplying openings 21 to prevent leakage of toner during toner supplying operation.

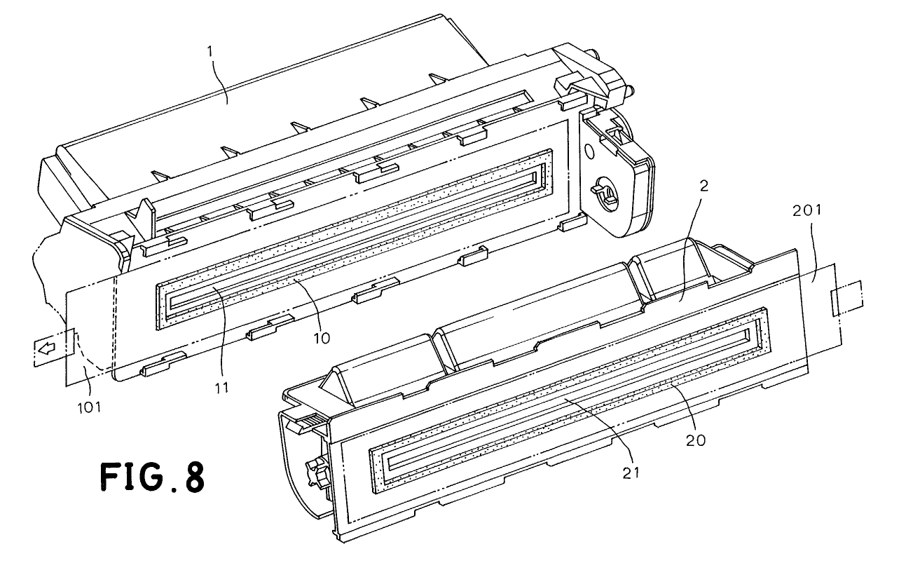

Referring to FIG. 8, the aforesaid blocking member, according to a second embodiment of the present invention, comprises a first strippable strip of sealing film 101 covered on one side of the developing device 1 to seal the toner receiving openings 11, and a second strippable strip of sealing film 201 covered on one side of the toner container 2 to seal the toner supplying openings 21. Alternatively, the blocking member can be made having only one strippable strip of sealing film covered on one side of the developing device 1 (or toner container 2) to seal the toner receiving openings 11 (or supplying openings 21).

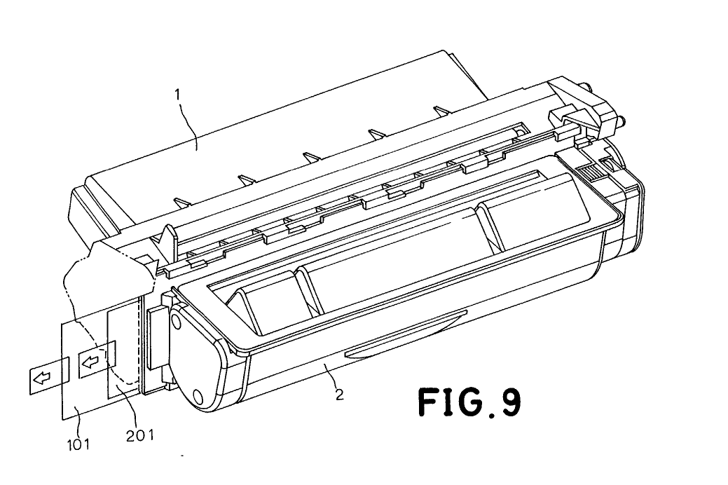

Referring to FIG. 9 and FIG. 8 again, when the toner container 2 and the developing device 1 coupled together, the first strippable strip of sealing film 101 and the second strippable strip of sealing film 201 are pulled outwardly away from the developing device 1 and the toner container 2 respectively, thereby causing the toner passage between the toner receiving openings 11 of the developing device 1 and the toner supplying openings 21 of the toner container 2 to be opened.

A prototype of process cartridge toner supply arrangement has been constructed with the features of FIGS. 1˜8. The process cartridge toner supply arrangement functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A process cartridge toner supply arrangement comprising:
a receiving member, said receiving member comprising a plurality of toner receiving openings and a toner accommodating portion adapted for accommodating toner received from said toner receiving openings;
a supplying member, said supplying member comprising a toner accommodating portion adapted for accommodating toner and a plurality of toner supplying openings adapted for supplying toner from the toner accommodating portion of said supplying member to the toner accommodating portion of said receiving member through said toner supplying openings and said toner receiving openings; and
a blocking member provided between said receiving member and said supplying member and moved to close/open the toner passage between said toner receiving openings and said toner supplying openings.

2. The process cartridge toner supply arrangement as claimed in claim 1, wherein said blocking member comprises a second sliding cover coupled to said receiving member and moved relative to said receiving member to close/open said toner receiving openings, a second sliding cover coupled to said supplying member and moved relative to said supplying device to close/open said toner supplying openings, and engagement means provided in said receiving member and said supplying member for enabling said first sliding cover and said second sliding cover to be moved synchronously to simultaneously close/open said toner supplying openings and said toner receiving openings, said engagement means comprising projection means and recess means adapted for receiving said projection means.

3. The process cartridge toner supply arrangement as claimed in claim 2, wherein said projection means of said engagement means comprises a projection rod protruded from said first sliding cover and engaged into said recess means at said supplying member.

4. The process cartridge toner supply arrangement as claimed in claim 3, wherein said recess means of said engagement means comprises a retaining hole disposed in said supplying member in line with said toner supplying openings at one side and adapted for receiving said projection rod.

5. The process cartridge toner supply arrangement as claimed in claim 2, wherein said second sliding cover comprises a plurality of openings corresponding to said toner receiving openings.

6. The process cartridge toner supply arrangement as claimed in claim 3, wherein said receiving member comprises a sliding slot for the passing of said projection rod to the outside of said receiving member to engage said recess means at said supplying member.

7. The process cartridge toner supply arrangement as claimed in claim 2, wherein said receiving member comprises two elongated guide members arranged in parallel at different elevations above and below said toner receiving openings and adapted for guiding movement of said first sliding cover to close/open said toner receiving openings.

8. The process cartridge toner supply arrangement as claimed in claim 2, wherein said first sliding cover comprises a plurality of openings corresponding to said toner receiving openings.

9. The process cartridge toner supply arrangement as claimed in claim 2, wherein said supplying member comprises two elongated guide members arranged in parallel at different elevations above and below said toner supplying openings and adapted for guiding movement of said second sliding cover to close/open said toner supplying openings.

10. The process cartridge toner supply arrangement as claimed in claim 2, further comprising a sponge lining fixedly provided between one side of said receiving member and said first sliding cover around said toner receiving openings.

11. The process cartridge toner supply arrangement as claimed in claim 2, further comprising a sponge lining fixedly provided between one side of said supplying member and said second siding cover around said toner supplying openings.

12. The process cartridge toner supply arrangement as claimed in claim 6, wherein said projection means of said engagement means further comprises a plurality of projections respectively protruded from said second sliding cover around openings of said second sliding cover corresponding said toner receiving openings and adapted for engaging into said toner receiving openings.

13. The process cartridge toner supply arrangement as claimed in claim 1, further comprising a strippable strip of sealing film covered on said receiving member to close said toner receiving openings.

14. The process cartridge toner supply arrangement as claimed in claim 1, further comprising a strippable strip of sealing film covered on said supplying member to close said toner supplying openings.

15. The process cartridge toner supply arrangement as claimed in claim 13, further comprising a sponge lining installed in said receiving member around said toner receiving openings.

16. The process cartridge toner supply arrangement as claimed in claim 14, further comprising a sponge lining installed in said supplying member around said toner supplying openings.
